(19) United States
(12) Patent Application Publication
(10) Pub. No.: US 2026/0330392 A1
(43) Pub. Date: Oct. 22, 2026

(54) MARKSMANSHIP SKILL PERFORMANCE PREDICTION

(71) Applicant: AccuShoot, Inc., Corvallis, OR (US)

(72) Inventors: Francisco Martin, Corvallis, OR (US); Poul Petersen, Corvallis, OR (US); Ken Baldwin, Albany, OR (US); Rick Hangartner, Corvallis, OR (US); Atakan Cetinsoy, Las Vegas, NV (US); Jim Shur, Barcelona (ES); Alvaro Clemente, Madrid (ES); Beatriz Garcia, Valencia (ES); Felix Martin, Seville (ES); Sergio de Simone, Barcelona (ES); Victor J. Fuente, Madrid (ES); Pablo Gonzalez, Valencia (ES); Oscar Rovira, Valencia (ES); Candido Zuriaga, Valencia (ES)

(21) Appl. No.: 19/486,912

(22) PCT Filed: May 22, 2024
(86) PCT No.: PCT/US2024/030662

§ 371 Date: Nov. 21, 2025

Related U.S. Application Data
(60) Provisional application No. 63/503,636, filed on May 22, 2023.

(51) Int. Cl. G06Q 10/0639

(52) U.S. Cl. CPC G06Q 10/06398

(57) ABSTRACT

A performance prediction system is configured to predict a future performance of a perishable skill based upon a weighted training regime schedule. For example, the performance prediction system can determine how future performance will be impacted by failure to conduct regular training. In this case, the performance prediction system may generate statistically sample performances and determine a likely level of future performance based on a level of current skill, a lack of training, stressful environment, among other factors.

### CROSS-REFERENCE TO RELATED APPLICATIONS

The present application claims priority to U.S. Provisional Application No. 63/503,636, filed on 22 May 2023, the entire contents of which are incorporated by reference.

### BACKGROUND

Marksmanship (particularly Shooting Precision) is considered to be a perishable skill, that is, a skill in which performance decays “fast” (usually considered with a half-life of less than 2.5 years) over time if it's not maintained with proper training and with enough frequency and volume.

Currently, there is no way to quantify how much or what type of training is required to maintain this perishable skill. Moreover, marksmanship greatly depends on the type of firearm, as a shooter may perform well with a particular type of weapon and perform very differently with a different type of firearm. Similarly, a shooter may perform well in a given shooting position and perform differently in a different shooting position. Moreover, there is no way to quantify whether additional training will increase a shooter's marksmanship.

It would be advantageous if this perishable skill, and other perishable skills, could be quantified to predict degradation or improvement based upon training or a lack thereof.

### SUMMARY

Using data on previous engagements (D.O.P.E.), we can estimate the current performance and a skill profile of a user, and build a machine learning (ML) model of the expected performance as time passes without proper and regular training. Moreover, the opposite is also true, that using a properly trained ML model can be used to predict a performance improvement of a user. The trained ML model can be developed to a very specific combination of one or more of user, type of firearm, specific firearm, caliber, type of ammunition, manufacturer of ammunition, shooting position, distance to target, time of shooting string, among others.

According to some embodiments, a machine learning system is configured to generate a future performance of a shooter, the system configured with instructions to receive historical shooting performance data of a user, the historical shooting performance including shot data from a plurality of targets at a plurality of shooting distances and a plurality of weapons and cartridges; normalize the shot data relate to a point of aim to generate normalized shot data; estimate the means and the variances in the normalized shot data by applying an exponential weight decay on both X and Y coordinates; generate a time-based a reduction factor, the time-based reduction factor indicative of a training cadence; generate a constant stress factor, the constant stress factor indicating two standard deviations of X and Y; generate, based at least in part on the normalized data, the exponential weight decay, the time-based reduction factor, and the constant stress factor, a future shooting performance; and determine performance metrics of the future shooting performance.

The system may further be configured to generate, based at least in part on the performance metrics of the future shooting performance, a training regimen designed to improve performance.

The instructions may be stored on non-transitory memory and the system may further include one or more processors that carry out the instructions, when executed. The instructions may be stored as modules and executed by the one or more processors to carry out the steps and methods described herein.

The system may be trained on training data, and the instructions further cause the system to iterate on the training data to improve on a machine learning prediction model. For example, the system may generate a predicted shooting score and the predicted shooting score may be compared with an actual shooting score to evaluate the accuracy of the prediction. The system may be updated with this type of training to improve the accuracy of the prediction, as is known by those of skill in the machine learning arts.

According to some embodiments, a computer-implemented method comprises selecting filters to perform a prediction model; retrieving previous performance sessions for a first user; generating a performance model for the user; applying external factors; generating a simulated shooting string for the user; and generating performance metrics of the simulated shooting string.

The method may further include generating, based at least in part on the performance metrics of the simulated shooting string, one or more exercises for the user to perform to improve the performance metrics.

The method may further include retrieving previous performance session for a second user, generating a performance model for the second user; and generating a simulated shooting string for the second user. In some examples, the method may include retrieving, showing, and generating shooting data for a group of users, and may compare and contrast individual users of the group with other members of the group.

In some cases, the step of generating a simulated shooting string for the user is based upon one or more of a selected weapon, a selected target, a selected distance, and a selected cartridge which includes a bullet weight, a powder type, and a powder loading. In general, a cartridge includes a bullet, a casing, a primer, and powder; however, not all of these components need to be individually selectable by the user. The user may have selectable filters that allow the user to generate a simulated shooting string based upon the selectable filters.

The method may include displaying a user interface, on a computing display that shows the previous performance sessions and the performance metrics of the simulated shooting string. The user interface may include user-selectable filters that include one or more of a type of firearm, distance to a target, and a stress factor. In some cases, the user interface further includes data on previous engagements for the first user.

In some examples, the method includes comparing the performance metrics of the simulated shooting string and an actual shooting string and updating, based at least in part on the actual shooting string, the prediction model. In this way, the system may be iteratively trained on ground truth data to improve the performance prediction model.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

The following drawing figures, which form a part of this application, are illustrative of described technology and are not meant to limit the scope of the technology as claimed in any manner, which scope shall be based on the claims appended hereto.

FIG. 1 illustrates an exponential decay of a perishable skill over time, according to some embodiments.

FIG. 2A illustrates recorded shots associated with a marksman, in accordance with some embodiments.

FIG. 2B illustrates a heat map associated with the recorded shots of FIG. 2A that may be used by a machine learning model to predict future performance, in accordance with some embodiments.

FIGS. 3A and 3B illustrates a current skill level of a marksman (Raw) and an adjusted performance at 11 weeks and 25 weeks, respectively without sufficient ongoing training, in accordance with some embodiments.

FIG. 4 illustrates a sample user interface for a performance prediction system, in accordance with some embodiments.

FIG. 5 illustrates another sample user interface for a performance prediction system that shows comparison across users, in accordance with some embodiments.

FIG. 6 illustrates some components of a performance prediction system, in accordance with some embodiments.

FIG. 7 illustrates a process flow diagram for predicting performance metrics, in accordance with some embodiments.

FIG. 8 illustrates a process flow diagram for generating a simulated shooting session for a user, in accordance with some embodiments.

### DETAILED DESCRIPTION

The disclosure sets forth example embodiments and, as such, is not intended to limit the scope of embodiments of the disclosure and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

A statistical approach may be used to build a machine learning (ML) model which takes into account (1) skill evolution over time by prioritizing recent performances over old recordings using a weighting scheme; (2) skill decay due to lack of training, modeling the perishable aspect of marksmanship; and (3) skill decrease due to affective measures, such as stress, worry, sickness, among others.

Machine learning (ML), a subset of artificial intelligence (AI), involves developing algorithms and statistical models that enable computers to learn from data and make predictions. The process begins with data collection, gathering relevant data from sources like databases, sensors, or user-generated content. Ensuring the data is representative and of high quality is important, as noisy or incomplete data can degrade model performance. Preprocessing the data involves cleaning, normalizing, handling missing values, engineering features, and splitting the data into training, validation, and test sets.

Model selection depends on the problem type—regression, classification, or clustering, for example. Supervised learning uses labeled data with algorithms like Linear Regression, Support Vector Machines (SVM), and Neural Networks, while unsupervised learning uses unlabeled data with methods such as K-means Clustering and Principal Component Analysis (PCA). Semi-supervised learning combines both labeled and unlabeled data, and reinforcement learning involves learning through interaction with an environment to maximize rewards.

Training the model involves optimizing its parameters to minimize a loss function, which measures the difference between predicted and actual values. Optimization algorithms, such as, without limitation, Gradient Descent and Adam, may be employed, and the process includes multiple epochs and batch processing. After training, model evaluation on validation and test datasets ensures generalization to unseen data, using metrics like accuracy, precision, recall, and R-squared. Techniques like k-fold cross-validation help assess model performance, and the model may be checked for overfitting or underfitting by comparing training and validation results.

Hyperparameter tuning may be conducted to improve model performance through methods like Grid Search, Random Search, or Bayesian Optimization. Once the model is refined, it can be used to make predictions on new, unseen data through a process called inference. In some cases, a deployment phase integrates the trained model into a production environment, ensuring it can handle the required load and is continuously monitored for performance.

Finally, model maintenance involves regularly updating the model to adapt to new data and changing conditions. This may include retraining with new data, monitoring performance metrics, and detecting data drift.

With an algorithm and ML model in place, in some cases, we can replicate it with different subsets of the data, for instance, focusing on just rifles or pistols, so that you can get a more accurate representation of the skill given some restrictions. This can be used to better predict the performance with a given gun, or even a new one.

In some embodiments, shooting precision may be modeled by predicting the X, Y coordinates of the position of each of the shots inside the target. A system can be configured to model the coordinates as an uncorrelated bivariate normal, that is, the X and Y dimensions are independent of each other, and each may be distributed as a Gaussian distribution.

In some cases, it may be helpful to ignore the bias of the precision distribution, which means that the mean of the associated Gaussian distributions are centered inside the target. In some cases this is useful since it's useful to assume that any bias can be corrected by sighting the firearm.

Using historical data extracted from registered previous sessions, the mean and the standard deviation can be estimated for each the associated Gaussian distribution on both X and Y coordinates, with a weighting factor proportional to the time since the recording of the session, which may be performed by using an exponential decay function, that may utilize the following formula:

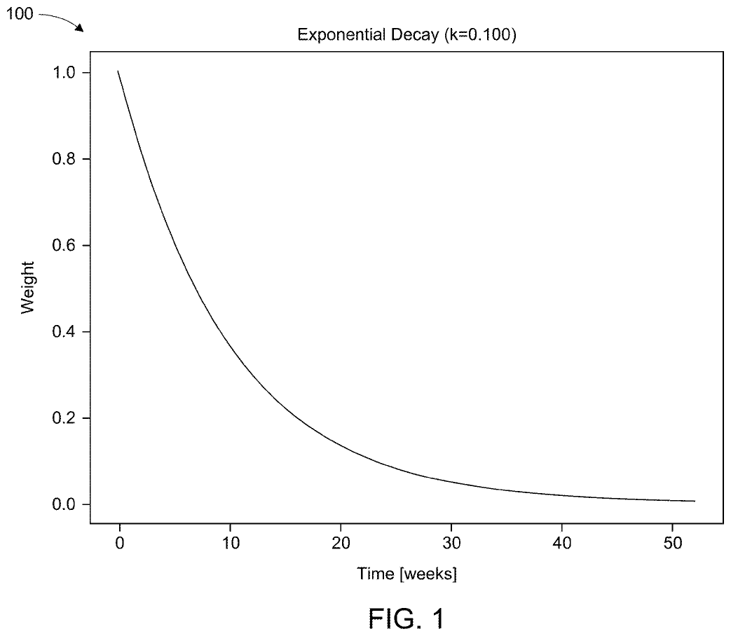

σₜ=σₒ (1+k)^{t}

Where k is an adjustable parameter, and t is how long ago the session happened in time. FIG. 1 illustrates this exponential decay function 100 showing the weighting factor as a function of time. The exponential decay function in combination with the weighted Gaussian distribution can be further used to generate a visualization of the current skill of the user.

Machine learning (ML) techniques are powerful tools for analyzing complex data and making predictions. Embodiments described herein are configured to predict future performance of marksman, with a proposed training schedule or with no further training. Various types of ML algorithms, along with feature engineering techniques, model evaluation methods, can be employed in the novel predictive models disclosed and used in real-world scenarios.

Predicting future performance involves forecasting the outcome or behavior of a system or entity based on historical data and other relevant factors. Machine learning, a subset of artificial intelligence, encompasses a diverse set of algorithms and techniques that enable computers to learn patterns from data and make predictions without being explicitly programmed. Leveraging ML for predicting future performance offers several advantages, including scalability, adaptability to diverse data types, and automation of decision-making processes.

According to some embodiments, machine learning approaches for predicting future performance can be categorized into supervised, unsupervised, and reinforcement learning. Supervised learning involves training a model on labeled data, where the algorithm learns to map input features to output labels. Common supervised learning algorithms for prediction tasks include linear regression, decision trees, random forests, support vector machines, and neural networks. Unsupervised learning techniques, such as clustering and dimensionality reduction, can be used to identify patterns and relationships in unlabeled data. Reinforcement learning focuses on learning optimal decision-making strategies through trial-and-error interactions with an environment.

Feature engineering involves selecting, transforming, and creating relevant features from raw data to improve model performance. Techniques such as normalization, scaling, encoding categorical variables, feature selection, and dimensionality reduction help in extracting meaningful information from input data while reducing noise and redundancy.

Evaluating the performance of predictive models can be used to assess their accuracy, generalization ability, and reliability. Common metrics for regression tasks include mean squared error (MSE), root mean squared error (RMSE), mean absolute error (MAE), and R-squared coefficient. For classification tasks, metrics such as accuracy, precision, recall, F1-score, and area under the receiver operating characteristic curve (ROC AUC) are commonly used. Cross-validation techniques, such as k-fold cross-validation, help in estimating the performance of models on unseen data.

Various machine learning algorithms, techniques, and opportunities to provide benefits to shooters of all skill levels are described and can be used to improve marksmanship, including skill retention and skill building to desired or required performance levels.

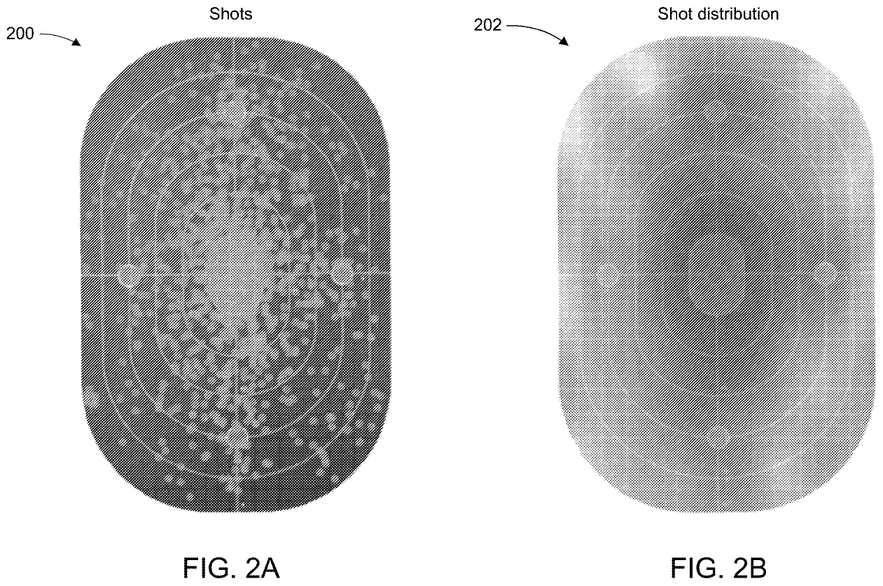

FIGS. 2A and 2B illustrate a shot distribution representative of the current skill of the user 200 and a heat map representative of the current skill of the user 202, respectively. In addition, the system may be configured to generate statistically relevant artificial sessions based on the performance model in view of the current skill.

According to some embodiments, a performance prediction system is configured to determine the current skill of a user, generate visualizations associated with the current skill, determine how the current skill is likely to deteriorate over time, including generating statistically relevant artificial sessions based on the skill deterioration over time.

Furthermore, the performance prediction system may be configured to determine, based at least in part on the current skill estimation, a model that predicts one or more of (1) future performance when no training is applied; performance under stress (e.g., real combat situations), and (3) future performance with no further training with the addition of stress.

For instance, according to some embodiments, the performance prediction system may be configured to update the parameters (e.g., standard deviation) of the expected position distribution by applying additional factors. In an embodiment in which the performance prediction system determines the expected position distribution while factoring in no training, a time-based linear factor may be added to the standard deviation, which may also include a scaling factor if k, where k is a percentage decrease in precision with each passing week relative to the initial timing. In some cases, the k% decrease is only applied to the initial timing and does not compound with each successive week. Where the performance prediction system factors for stress, a constant factor may be applied to shift the center randomly which may be according to a Gaussian distribution of N(0, c) and may also add a value s to the expected standard deviation.

Accordingly, in some embodiments, the performance prediction system may rely on instructions, that when executed by one or more processors of a computing device, cause the performance prediction system to perform acts including: collecting relevant historical data from sessions; normalizing the shot positions relative to the point of aim (POA) while removing bias; estimating the mean and the variance or standard deviation of the sampling, using weighting with decay factors for recent performance prioritization; adding noise based proportional to a time since last training session; and optionally add a constant factor based on stress. In some cases, the shot positions may be normalized with respect to POA across many different targets by employing a point system. For example, the shots on any real target may be projected into a standardized target with known characteristics (e.g., size and POA). Once the shorts are projected into this target, the points scored on the target can be computed. Therefore, when executing a standard drill on any real target, such as a slow drill, the shot pattern on the target can be projected onto a standardized target and scored for comparison.

As a further example, a session that uses any layout of a target may show a single shot that hits centered on the x-axis (e.g., aligned horizontally with the center of the bullseye), but is 1.5 inches above the center of the bullseye. On the real target at which the marksman is aiming, this may show an impact within the central scoring region, which shows a score of 10. However, when projecting this hit onto a standardized target that uses 1-inch concentric rings for scoring, this hit may be in the second concentric ring, which scores a 9. In this way, the system tracks a metric that focuses on measuring accuracy across targets over precision and allows a standardized way of tracking a marksman score irrespective of the physical target being shot at. Similarly, a silhouette target may be a real target at which the marksman is aiming at a specified POA. The shots taken on this silhouette target may be projected onto a normalized bullseye target with concentric rings and scored appropriately without regard to the size of the scoring rings on the silhouette target. A similar approach may be used with other metrics. For example, a group size metric may be used to measure precision without regard to the physical target used in the shooting string.

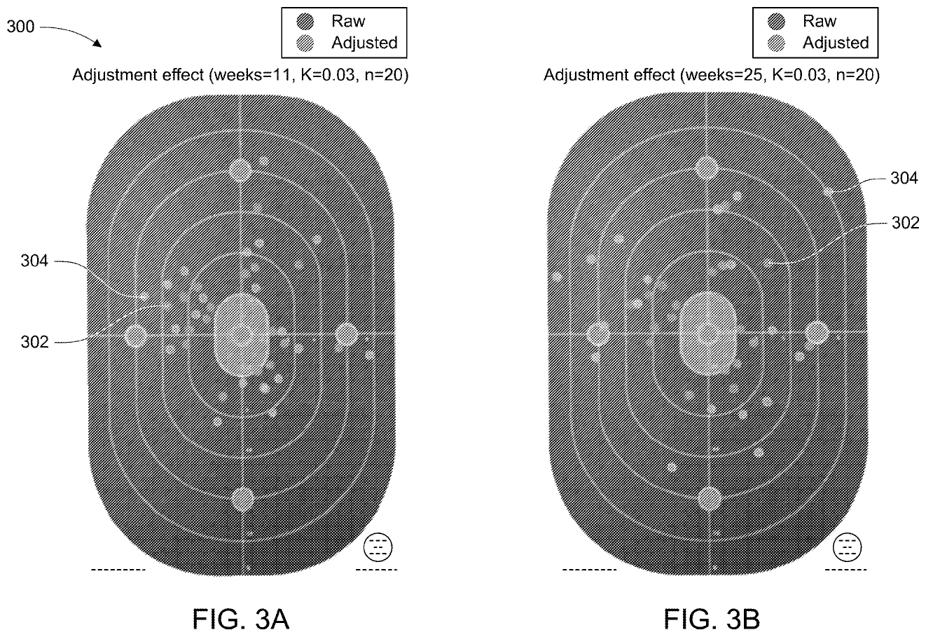

FIG. 3A illustrates a current skill level with shot placement 300 shown in a first indicia 302, and adjustment affects after 11 weeks of no training with a k of 0.03 shown in a second indicia 304. The second indicia 304 illustrates that once the time decay and noise are added, a predicted performance can be generated and shown relative to the current skill level. Similarly, FIG. 3B illustrates how the current skill level is predicted to vary after 25 weeks of no training with a k of 0.03.

By implementing a model utilizing an algorithm as described above, a model can be built given a sample of shots. By filtering the shots that are used to train the model (e. g: only ones that were shot with a Rifle), you can get a more specific model that predicts better the future performance with Rifles.

Accordingly, different models can be trained with subsets of the data that follow the hierarchy of the relevant ontology based on the subject of the performance. For example, when using the performance prediction system in a marksmanship application, the hierarchy may include: I. Gun, A. Rifle, 1. Beretta BRX1. Other ontologies are contemplated and may extend to different classes of firearms, such as, for example pistols, different distances, different time constraints or otherwise. Other ontologies may also allow a model to be built for very specific combinations of shooter, type of firearm, specific firearm, type of ammunition, manufacturer of ammunition, shooting position, range, and time of shooting string, among others. In addition, the performance prediction system may be applied to any perishable skill that requires continuous training in order to maintain a high degree of precision (e.g., repeatability and reproducibility) including, without limitation, archery, ice skating, skiing, basketball (e.g., free throw shooting), golf, football, darts, bowling, cue sports, among others.

Moreover, depending on the filters selected by the user, we can use the most specific model which will yield the best predictions, and a model may be tailored for a specific action, motion, sport, activity, and/or user. According to some embodiments, the performance prediction system presents a display to a user and allows the user to enter selections that correspond with a particular model associated with an ontology. As an example, the user may enter selections in a user interface that correspond with marksmanship, pistol, Glock 17 Gen5 MOS, and optional selections which may include one or more of ammunition, location of range, weather, amount of sleep the previous night, other shooters present, shooting position (e.g., off-hand, prone, sitting, kneeling, bench rest, moving, among others), and firearm accessories (e.g., sling, bipod, bench rest, stock weight, sights, scope, among others), distance from target, type of target, time to complete shooting string, and others.

In some cases, the marksman completes one or more drills in order to measure performance. The marksman may select one or more drills from a list of available drills, or may be prompted to complete a particular drill by the system. For example, a Group drill may encourage a marksman to shoot the smallest shot group and the location of the group on the target may not be very important to the scoring of the Group drill. A group or shot grouping is a pattern of projectile impacts from multiple consecutive shots taken during a shooting string or session. The tightness of the group may be expressed as a distance measure between the two furthest projectile holes in the target. The distance measurement may be converted into an angular measurement, (e.g., minutes of angle or “MOA”). The angular measurement is useful for expressing the size of the group regardless of distance to the target, and thus can be used to compare shot groupings taken from different distances.

A Slow drill may be completed and used to determine performance. A slow drill may encourage a marksman to shoot at specific parts of the target without regard to group size.

A Rapid drill encourages a marksman to hit a target with a rapid string of shots without scoring for accuracy or precision, but rather, registering a hit or miss. Any of a variety of drills may be used by the system, and in some cases, suggested by the system, in order to track and improve marksmanship over time.

In some cases, a current skill level is based upon one or more drills that are carried out and scored by the system. Similarly, the predicted performance may likewise be specific to one or more drills that may be carried out in the future. An example model may be tailored to an Accuracy and Precision drill with a focus on group size and simple slow drills which may include a bullseye style target with a single centered POA. A present value from such a drill may then be used to forecast future performance based upon the subsequent training regimen and the predicted performance may show an improvement or a deterioration.

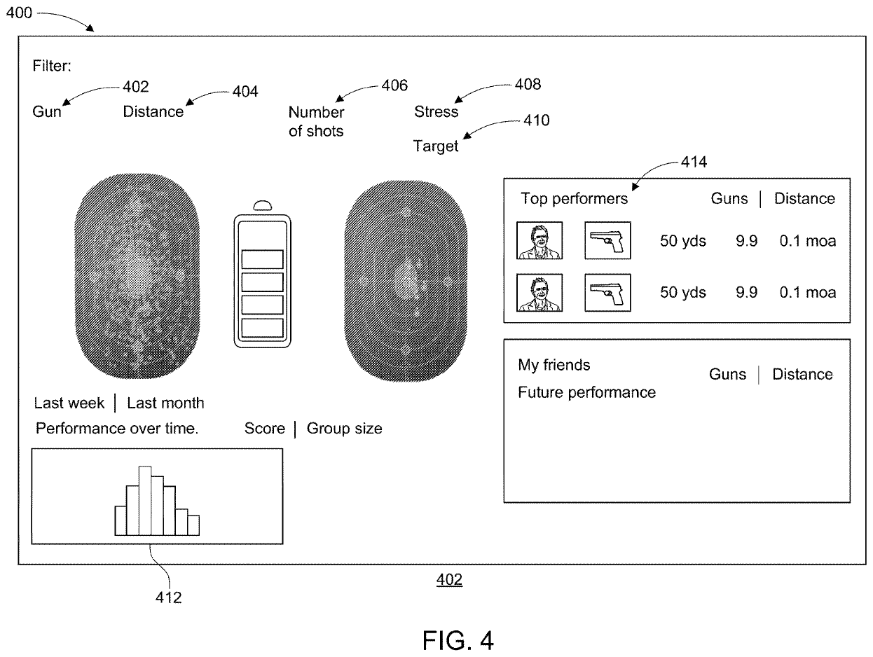

FIG. 4 illustrates an example user interface to the performance prediction system described herein. Of course, a user interface may display many different filters and information. In the illustrated example, the user interface 400 is displayed on a display. In some cases, the display may be associated with a mobile computing device, a laptop, a desktop computer, a television, or other display device.

The user interface 400 may include user-selectable filters, such as, for example, a type of gun 402, cartridge type, shooting position (e.g., offhand, sitting/kneeling, prone, supported, etc.), a distance to the target 404, a number of shots 406, a stress factor 408, a target type 410, drill type, biomedical factors (e.g., time since last meal, number of hours of sleep in the previous 24 hours, blood sugar levels, alcohol consumption) among others.

Data on previous engagements (DOPE) 412 may be displayed to indicate historical performance of the user. In some cases, other user data 414 may be displayed to show comparisons between the user and other users, such as friends or colleagues. In some cases, a top performer may be displayed which may be based on the top performer for a given session, for a current day, week, month, all-time, or some other filters such as firearm, geography, friend list, range location, among others.

According to some embodiments, the performance DOPE, also referred to as performance evolution, may result in a single number computed each day considering the discriminators such as drill, type of firearm, distance, privacy, or other discriminating factors. An estimation of a user's expected skill level may be computed on a regular interval, such as every day, every week, or some other desired time period. The expected skill level may be computed by taking the most relevant model available at that time (e.g., the most recently trained model) and generating N sessions (e.g., 50) and computing the metrics from these generated sessions. The estimation thus generates an expected score for the user and may further include confidence bands. The result is that the estimation may reflect a user's intrinsic skill at that point, taking everything into account rather than relying solely on a singular performance on a given day that may be affected by many factors such as weather conditions, affective measures, luck, distractions, emotional factors, among others. In other words, the system may estimate the skill level of a marksman on a particular day that may be higher or lower than an actual singular shooting performance. An actual shooting performance may be compared with the estimated skill level to determine whether the actual shooting performance is within the expected range of the estimated skill level.

In some cases where the actual shooting performance is below the expected range of the estimated skill level, the system may prompt the user to complete additional shooting strings, drills, or other forms of training to increase the actual shooting performance to be within the expected range of the estimated skill level. The system may further diagnose a mechanical issue with the firearm and/or ammunition combination and suggest remedial actions. For example, the system may determine that the actual performance of the shooter is likely a result, at least in part, of fouling of the firearm such as a carbon buildup or other substance in the firearm. Additionally, the system may recommend a different ammunition for the firearm. For example, where a marksman is shooting a relatively long distance (e.g., 200 yards or more), the system may recommend a heavier bullet, such as a 78 grain bullet in lieu of a 55 grain bullet currently being used. Furthermore, the system may be configured with a prioritized approach to improving a shooters performance. The prioritized approach may include one or more of improving the shooter, ammunition, maintenance, or mechanics. The system may further recommend drills to improve shooter skills, better ammunition, cleaning or fixing the firearm, adjusting sights on the firearm, improving or replacing components, such as firearm optics, barrels, triggers, firing pins, or other components.

The system may be trained on training data that correlates a decline in actual performance with one or more of the prioritized approach metrics. For instance, where a shooter's performance is acceptable at close range and then deteriorates significantly at a greater distance, the system may look for factors that result in a degraded performance with the increase in range. For example, the system may determine that the particular firearm/ammunition combination is the result of the reduced performance. For example, if a barrel has suboptimal rifling, if the bullet is too light, if the barrel is too short, each of these factors could result in a firearm that is incapable of scoring well at a greater distance, which may not be the result of the marksman's true ability. The system may be configured to correlate reduced performance with one or more of the prioritized approach metrics, such as one or more of improving the shooter, ammunition, maintenance, or mechanics, and make recommendations to the marksman to improve their score.

In some cases, a user may have access to privacy settings of the system and can decide what to share and to whom the results should be shared. In some cases, a shooting performance or series of shooting performances that are viewable by the public may be different from sessions that friends of the user may see, which may also be different from the sessions that are viewable only to the user. The trained models may respect the privacy settings and depending on the level of privacy chosen by the user, the user will see a model trained with sessions that are chosen from a set of sessions that respect the privacy level.

For instance, when looking at a user's private performance, all sessions may be included. However, when looking at a user's public performance, such as sessions that can be viewed by any user which may be through the rankings, the public performance may be shown through a model trained from public sessions only. As another example, a user may choose to only make public the shooting sessions taken with a handgun, rather than including sessions performed with a semiautomatic, or fully automatic, rifle. This may further aid in competitive shooting in which multiple shooters compete with one another by using similar, or the same, firearms. This allows sessions taken with other firearms that are not part of the competition to be excluded from the scoring sessions of the competition.

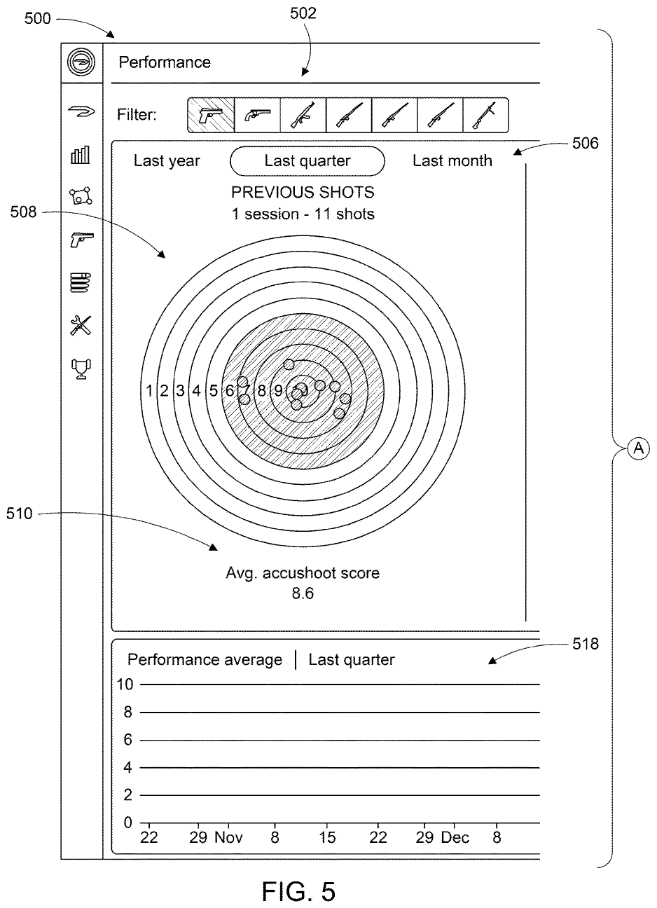

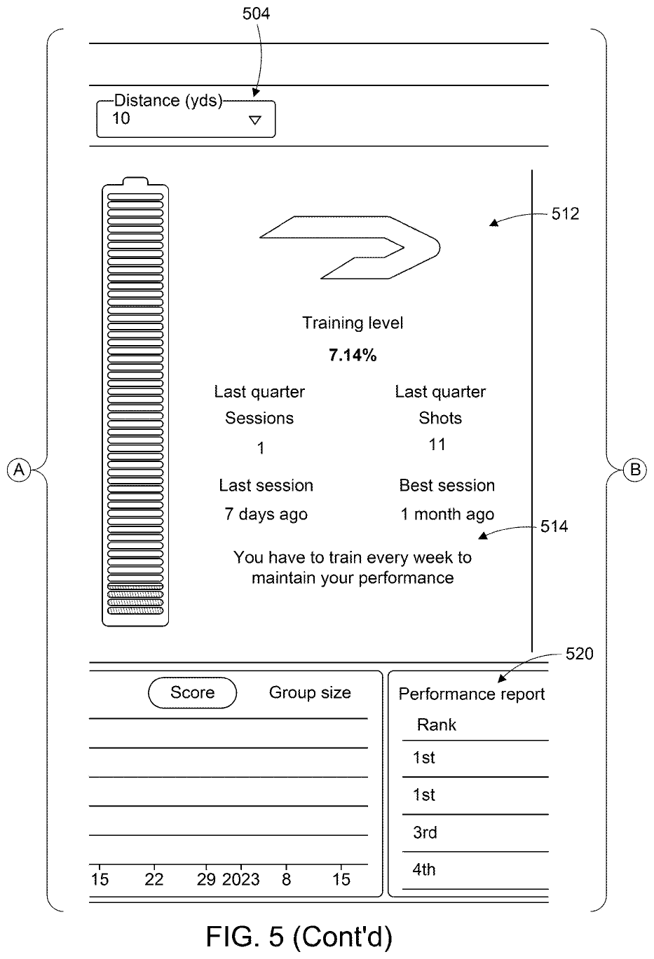

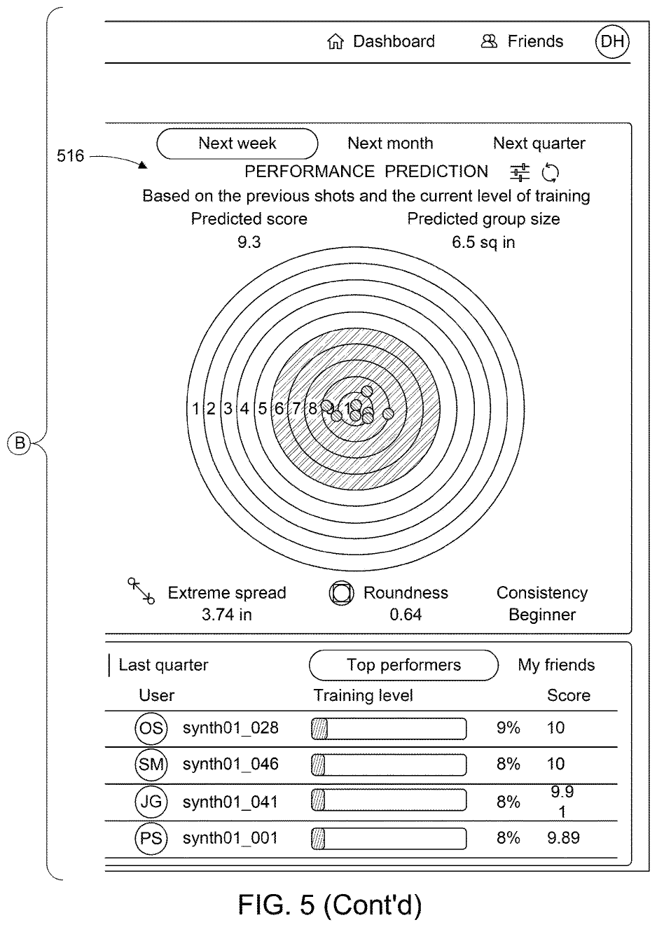

FIG. 5 illustrates another example user interface 500 for a performance prediction system. The user interface 500 may include selectable filters, such as, for example, a list of firearms 502 which may be customizable based upon the firearms a user owns or has access to. The list of firearms may be general, such as allowing a user to select a pistol or a long gun, for example. It may further allow a more specific selection of firearm, such as a revolver, semi-automatic pistol, etc. It may further allow a very specific firearm selection, such as a Glock 17 Gen5, Smith and Wesson model 59, or SIG Sauer P226, among others. Finally, the list of firearms may further allow a user to select a specific cartridge, such as a 115 gr 9 mm round nose or a 124 gr 9 mm FMJ, or others. In many embodiments, the system is configured to create a personalized model for each specific combination of user, firearm, and shooting position. Other filters may include one or more of a distance to target 504, a shooting position, a cartridge, a time frame 506, type of drill, previous shots normalized 508, prior scores 510 which may include a rolling average score of a determined time frame, a training level 512 and a recommended training regime 514. The training regime 514 may indicate a recommended training cadence in order to maintain the level of training and may alternatively or additionally indicate a recommended training regime, which may include exercises, to improve the user's marksmanship. A performance prediction 516 may indicate, based on the previous shots and the current level of training, a predicted score, a predicted group size, a predicted improvement or deterioration based upon a training regime, among others.

The user interface may indicate a performance average 518, which may be filtered by a date range. A performance report 520 may display data indicative of performance and/or predicted performance for a group of shooters. This may be helpful, for example, where it is desirable to track a group of shooters, such as for law enforcement, military, competitive shooters, among others.

In some cases, the user interface is configured to pull data from a remote source, such as one or more remote servers, cloud-based computing resources, or other form of data warehouse that stores historical performance data. The user interface 500 may be displayed on any suitable display device and may be configured to provide information that allows the shooters to schedule, plan, and track improvement metrics over time. In some cases, the performance prediction system recommends a training schedule and regime for allowing individual shooters to improve their marksmanship. The performance prediction system may recommend a training cadence (e.g., shoot 50 rounds per week) in order to improve marksmanship. The training cadence may be based, at least in part, on historical training session performance which may include a number of rounds fired in a given time period coupled with the scoring results of those prior training sessions.

The performance prediction system as described herein may be executed by one or more processors and include instructions stored on memory. For example, the performance prediction system may include one or more processors, such as a central processing unit (CPU), a graphical processing unit (GPU), both CPU and GPU, a microprocessor, a digital signal processor or other processing units or components known in the art. Alternatively, or in addition, the functionality described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program modules, program data, and/or one or more operating systems. The one or more control systems, computer controller and remote control, may include one or more cores. In some cases, the performance prediction system may be implemented on a mobile computing device, such as, for example, a smartphone, a tablet computer, a laptop computer, a cloud-based computing platform, or other type of computing device with which the user can interact. In some cases, the computing device includes a camera and may be configured to capture one or more images of a target, and in some cases, can recognize hits on the target and score the target.

Embodiments may be provided as a computer program product including a non-transitory machine-readable storage medium having stored thereon instructions (in compressed or uncompressed form) that may be used to program a computer (or other electronic device) to perform processes or methods described herein. The computer-readable media may include volatile and/or nonvolatile memory, removable and non-removable media implemented in any method or technology for storage of information, such as computer-readable instructions, data structures, program modules, or other data. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks.

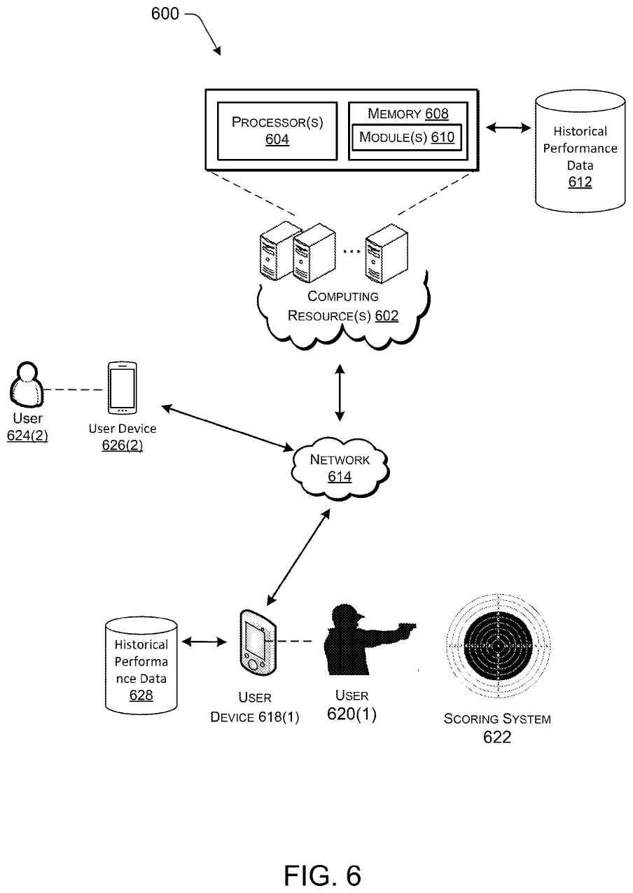

FIG. 6 illustrates an example embodiment of a performance prediction system 600 that may be configured and used with any of the embodiments described herein. In some cases, computing resources 602 may be used to compile, store, aggregate, and/or disseminate information usable by other components within, or connected to, the system 600. The computing resources 602 may have one or more processors 604 and memory 608 accessible by the processors to execute one or more modules 610 that cause the performance prediction system 600 to perform acts. In some cases, the computing resources 602 may have access to historical performance data 612 which may include performance data associated with one or more users of the performance prediction system 600.

The computing resources 602 may be accessible over a network 614, such as the internet. A user device 618(1) may be associated with a user 620(1) and may have permissions to allow the user 620(1) to access the performance prediction system 600 to view and save data. In some cases, where the performance prediction system 600 is used within the context of marksmanship, a target scoring system 622 may additionally be used to score a shooting session and send the results to the computing resources 602 for storage, comparison, and/or analysis. A scoring system 622 may include a computing device having a camera and/or a microphone. The scoring system 622 may be a special purpose machine that is configured to capture images of a target, detect impacts on the target, and score the target. The scoring of the target may include one or more of determining a score of each individual impact, a total score of all the impacts in a shooting string, and a group size of the impacts. The scoring system may further capture audio, such as by accessing a microphone of the computing device, associated with the shooting string, which can be used by the scoring system to ascertain when a firearm of the user is discharged, which may prompt the scoring system to capture images of the target to detect impacts on the target. In some cases, the scoring system is configured with machine learning to determine when a user's firearm is discharged, capture images of the target, detect new impacts on the target, score the target, and store the scoring information for analysis. The scoring information may be used with the predictive models disclosed herein. As with any of the disclosed embodiments, the scoring system and predictive models can be used in conjunction to provide real-time scoring, scoring tracking, training history, generated training regimens, and future scoring predictions based on a training regimen. According to some embodiments, the system is configured to determine a user's current skill level, including deficiencies in accuracy and/or precision, predict a future performance based on a training regimen, and generate a training regimen for the user in order to improve the user's future performance. The system, in generating a training regimen, may take into account a user's current skill and any determined deficiencies. The system may further generated a training regimen in order to improve a user's skill to a desired skill level and may recommend specific drills, targets, shooting strings, or otherwise to focus the improvement on one or more of the user's deficiencies.

In some embodiments, the user device 618(1) may further include historical performance data 628 associated with the user 620(1), which the historical performance data 612 associated with the computing resources 602 may include agglomerated historical performance data for a number of users. second user 624(2) may also have a user device 626(2) that is configured to access and use the performance prediction system 600 as described herein. The second user device 626(2) may store local performance data associated with the second user 624(2) and may additionally or alternatively send the performance data associated with the second user 624(2) to the computing resources 602 to be stored and/or analyzed remotely.

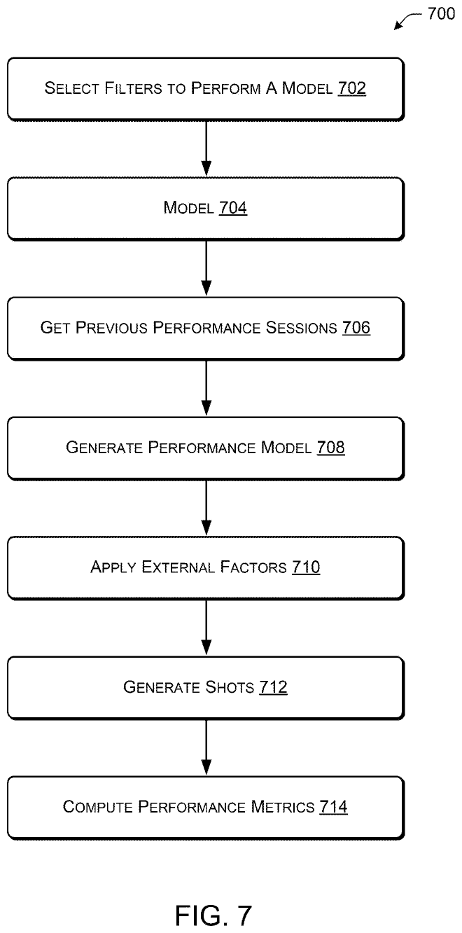

FIG. 7 illustrates a process diagram for predicting performance metrics 700, in accordance with some embodiments. In some cases, at block 702, a set of filters can be selected to perform a model. In some cases, the filters are selected by the system based upon the input factors. For instance, the system may get a queryset with the potential candidates for performance estimation and the system may filter only the ones that have new data within a reference time, and the system may return a list with the candidate set of filters for performance estimation.

At block 704, for each set of filters, the system may get the relevant sessions (e.g., DOPE) and use them to compute the performance model used to generate performance predictions. This may include, such as at block 706, getting previous performance sessions based on the set of filters for purposes of performance prediction, and the most recent may be processed first, or weighted heavier than older session in some cases.

At block 708, the system generates the performance model within the performance sessions obtained. Generating the performance model may further include returning the number of sessions, shots, mean and standard deviation for each coordinates, among other things. In some cases, the system may implement Multivariate Gaussian Distribution to model the coordinates of the shots, using exponential weight decay to give more importance to recent samples vs older ones when estimating the mean and variance of the shot distribution.

The system may proceed to standardize hits. This may include retrieving DOPE which may include shot coordinates, target dimensions, a normalized POA, among other data, and the shots may be standardized. The system may standardize shots by normalizing the coordinates of the shot hits in the space of the Standard Performance Target, so that both normalized (X, Y) coordinates represent the sma3e physical distance and can be easily represented with shots from other sessions. This allows drills from various distances to be normalized and included in the performance prediction, such as by maintaining the position of the shots relative to the POA.

The system may further computer time-based weights, such as by using exponential decay weights for the given time arrays. The system may determine means, standard deviations, and remove misses.

At block 710, the system applies external factors. The external factors may include anything may affect the expected performance, such as, without limitation, time since last training, stress level, last meal, quantification of sleep in a time period, alcohol consumption, among others. In some cases, the external factors result in a linear noise to the standard deviations and the mean may be shifted based on the stress level given “t” periods.

At block 712, the system generates shots, which is a prediction of a shooter's performance based upon the previous steps in the process flow.

At block 714, the system computes performance metrics. In some cases, computing the performance metrics includes one or more of determining score, determining group size, determining extreme spread of shots on target, determining roundness, and determining consistency. Through this process, the system can predict a shooter's score based not only upon DOPE, but also based on external factors and quality and quantity of training in a given time period.

In other words, the system can be configured to pre-compute a statistical model of each combination of distance, firearm, and ammunition for each participant. For each shooting session, independently of the target, for each distance, for each gun including each general type, for each ammunition including each general type, and normalize shots in a shooting session.

For all normalized shots sorted and weighted by most recent in time, the system can be configured to determine the mean X distance and mean Y distance to the center of the normalized target; the standard deviation for the distance of each shot and the X axis to the center; and the standard deviation for the distance of each shot on the Y axis to the center.

The system may, for each shot X, Y coordinates, determine the distance to PoA and translate it to a target where the PoA is 0,0 and has N concentric rings, from R_1 to R_N, with a respective radius of 1 * r, 2* r to N * r where r is a constant.

The system may estimate the performance for “t” periods of time (in days, weeks, or months) from a given date. This may be done by applying time since last training to the standard deviations to the model, while adding a linear noise to the standard deviations; applying a stress level to the means and standard deviations of the model by shifting the means given “t” periods and adding time independent noise to the standard deviations.

The system may use the new means and standard deviations to generate a sample of predicted performed shots. The predicted performed shot may be scored, and the system may determine a group size, extreme spread, roundness, consistency, among other factors.

The result is a system that is configured to model the precision of a user and the effect of the user's training regime over time, and is able to predict both improvements and deterioration of a user's skill. The assumption is that a user's previous engagements are distributed according to an uncorrelated bivariate normal, that is, the X and Y coordinates of a shot are independent of each other. We may also ignore any bias in the user's aim, assuming that it can be corrected by sighting the firearm. With this in mind, historical data is used as a sample for estimating the variance of the normal distributions for X and Y positions in the target. A decay factor may be applied to weight more heavily in favor of recent sessions vs older data. A first noise factor may be applied to model the decay in precision over time without training. A second noise factor may be applied to model the negative effects on the precision from stress. This may tend to shift the center randomly with a N(0, c), and it adds a value s to the expected standard deviation.

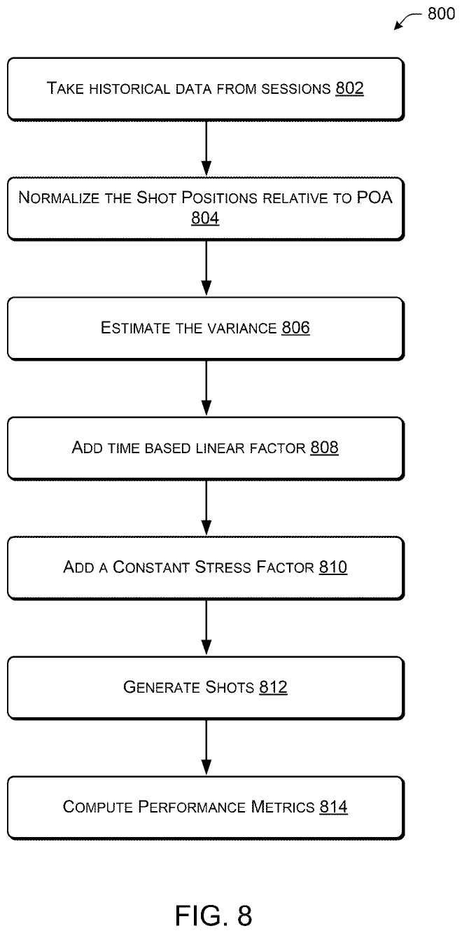

FIG. 8 illustrates a process flow diagram for generating a simulated shooting session for a user. At block 802 the system may take relevant historical data from sessions. At block 804, the system may normalize the shot positions relative to the POA. In some cases, this may be done while assuming perfect centering ability with no bad habit shot bias. Since we don't have the “real” (user reported) POA, the system may estimate it by computing the group center for each session.

At block 806, the system may estimate the variance/standard deviation of the sample. For instance, the system may apply a time based (weeks since last training) exponential weight decay (with decay factor k=0.1) t=0 (1+k)t. At block 808, the system may add a time-based linear factor to the standard deviation, with a scaling factor of k=0.03.

This can be interpreted as “every week your precision gets 3% worse”, relative to the initial time only, not compounding.

In some examples, the system may optionally add a constant factor based on stress. This has the effect of shifting the centering with a random value sampled from N(0, c) (where c=0.1) and incrementing the computed Standard Deviation by s (where s=0.05). Of course, other values may be utilized and the provided values are illustrative only.

This provides two Standard Deviation values (one for X and one for Y) that the system may then use inside a normal distribution to generate random samples of shots, generating as many simulated sessions as you want. As the center (mean) of the distribution we can point to the center of any target.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the

The specification and annexed drawings disclose examples of systems, apparatus, devices, and techniques that may provide control and optimization of coolant flow through core assemblies. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The methods described in relation to embodiments herein may be implemented by one or more processors executing instructions that cause the processors to carry out the disclosed methods.

Throughout the instant specification, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A machine learning system configured to generate a future performance of a shooter, the system configured with instructions to:
receive historical shooting performance data of a user, the historical shooting performance including shot data from a plurality of targets at a plurality of shooting distances and a plurality of weapons and cartridges;
normalize the shot data relate to a point of aim to generate normalized shot data;
estimate a mean and a variance in the normalized shot data by applying an exponential weight decay on X and Y coordinates associated with the normalized shot data;
generate a time-based a reduction factor, the time-based reduction factor indicative of a training cadence;
generate a constant stress factor, the constant stress factor indicating two standard deviations of X and Y;
generate, based at least in part on the normalized data, the exponential weight decay, the time-based reduction factor, and the constant stress factor, a future shooting performance; and
determine performance metrics of the future shooting performance.

2. The system as in claim 1, wherein the system is further configured to generate, based at least in part on the performance metrics of the future shooting performance, a training regimen designed to improve performance.

3. The system as in claim 1, wherein the instructions are stored on non-transitory memory and further including one or more processors that carry out the instructions when executed.

4. The system as in claim 1, wherein the system is trained on training data, and the instructions further cause the system to iterate on the training data to improve on a machine learning prediction model.

5. A computer-implemented method, comprising:
selecting filters to perform a prediction model;
retrieving previous performance sessions for a first user;
generating a performance model for the user;
applying external factors;
generating a simulated shooting string for the user; and
generating performance metrics of the simulated shooting string.

6. The method of claim 5, further comprising generating, based at least in part on the performance metrics of the simulated shooting string, one or more exercises for the user to perform to improve the performance metrics.

7. The method of claim 5, further comprising retrieving previous performance session for a second user; generating a performance model for the second user; and generating a simulated shooting string for the second user.

8. The method of claim 5, wherein generating a simulated shooting string for the user is based upon one or more of a selected weapon, a selected target, a selected distance, and a selected cartridge.

9. The method of claim 5, further comprising a user interface, displayed on a computing display that shows the previous performance sessions and the performance metrics of the simulated shooting string.

10. The method of claim 9, wherein the user interface further comprises user-selectable filters that include one or more of a type of firearm, distance to a target, and a stress factor.

11. The method of claim 9, wherein the user interface further comprises data on previous engagements for the first user.

12. The method of claim 5, further comprising comparing the performance metrics of the simulated shooting string and an actual shooting string and updating, based at least in part on the actual shooting string, the prediction model.
